(19) United States
(12) Patent Application Publication
(10) Pub. No.: US 2016/0371847 A1
(43) Pub. Date: Dec. 22, 2016

(54) BACKGROUND PROFILES

(71) Applicant: Bonanza.com, LLC, Seattle, WA (US)

(72) Inventor: William Harding, Seattle, WA (US)

(21) Appl. No.: 14/706,964

(22) Filed: May 8, 2015

Related U.S. Application Data
(60) Provisional application No. 62/028,554, filed on Jul. 24, 2014.

(51) Int. Cl. G06T 7/00

(52) U.S. Cl. CPC G06T 7/0081; G06T 2207/10004

(57) ABSTRACT

A system for discriminating a subject from a background in a photograph. Embodiments are directed to an image processing server on which executes an image analysis engine configured to analyze a first digital image, the first digital image having a first subject and a first background, the analysis including a discrimination of the first subject from the first background. In one embodiment, the image processing server further includes a profile manager configured to store information about the first background in a background profile data store. In this embodiment, the image processing server further includes an image comparison component configured to compare a second digital image to data stored in the background profile data store, the comparison identifying whether the second digital image includes data that resembles the first background.

### CROSS REFERENCE TO RELATED APPLICATIONS

This patent application claims the benefit of and priority to U.S. Provisional Patent Application Ser. No. 62/028,554, filed on Jul. 24, 2014, titled “Background Burner,” the disclosure of which is hereby incorporated by reference for all purposes.

### BACKGROUND INFORMATION

For many years, image scientists and mathematicians have struggled with the problem of how to identify the foreground from the background in a static two-dimensional image. Currently, the only options that exist to accomplish this are to use a “green screen” (a background of uniform color) or a “motion scene” where a subject is separated from the background by the nature of its movement. Those solutions suffer from several problems. For instance, the green screen solution requires substantial effort to implement at the time the photograph is taken. Likewise, the motion scene option is of little value for still images. These and other shortcomings render the existing solutions inadequate. Improvements are needed in the area of distinguishing a subject from a background in a photograph.

### SUMMARY OF THE DISCLOSURE

Embodiments are directed to an image processing server on which executes an image analysis engine configured to analyze a first digital image, the first digital image having a first subject and a first background, the analysis including a discrimination of the first subject from the first background. In one embodiment, the image processing server further includes a profile manager configured to store information about the first background in a background profile data store. In this embodiment, the image processing server further includes an image comparison component configured to compare a second digital image to data stored in the background profile data store, the comparison identifying whether the second digital image includes data that resembles the first background.

### BRIEF DESCRIPTION OF THE DRAWINGS

Many advantages of the disclosure will become more readily appreciated as the same becomes better understood with reference to the following detailed description, when taken in conjunction with the accompanying drawings, briefly described here.

FIG. 1 is a functional block diagram of an exemplary computing device 100 that may be used to implement one or more embodiments.

FIG. 2 is a graphical illustration of a computing environment 201 in which embodiments of the invention may be implemented.

FIG. 3 is a functional block diagram generally illustrating photo processing components 300 which may implement the preferred embodiment.

FIG. 4 is a flow diagram generally illustrating a most basic process 400 for implementing background profiles in accordance with one embodiment.

FIG. 5 is a flow chart generally illustrating in greater detail a process 500 for comparing known background profiles against a new photo to determine whether they are a match.

FIGS. 6-9 are exemplary images of items against backgrounds, which the various images representing photos at various steps in a process for discriminating a subject from a background in the photos.

Embodiments are described below in detail with reference to these Figures, in which like numerals refer to like elements throughout

### DESCRIPTION OF EMBODIMENTS

Various embodiments are described more fully below with reference to the accompanying drawings, which form a part hereof, and which show specific exemplary implementations for practicing various embodiments. However, other embodiments may be implemented in many different forms and should not be construed as limited to the embodiments set forth herein; rather, these embodiments are provided so that this disclosure will satisfy formal statutory requirements. Embodiments may be practiced as methods, systems or devices. Accordingly, embodiments may take the form of a hardware implementation, an entirely software implementation, or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on various considerations, such as performance requirements of the computing system implementing the embodiment. Accordingly, the logical operations making up the embodiments described herein may be referred to alternatively as operations, steps or modules.

First, embodiments will be described as implemented in a sample system that implements certain embodiments of the invention. This sample system may be implemented using common or special purpose computing equipment programmed in accordance with the teachings of this disclosure. Next, embodiments will be described as implemented in one or more methods for better distinguishing a subject from a background of a photograph. Finally, examples will be provided to illustrate how the system and methods may be used in practice.

### Illustrative System For Discriminating Subject From Background

What follows is a technical description of a system that can take an arbitrary two-dimensional (2D) photograph and isolate a subject of the photograph from the background. The uses for the technology are numerous, including improved e-commerce photography. Industry professionals frequently pay large sums of money to create an image studio that allows them to take crisp pictures with a white background. If the same results were possible from a mobile phone camera, that would allow amateurs to compete with the professionals.

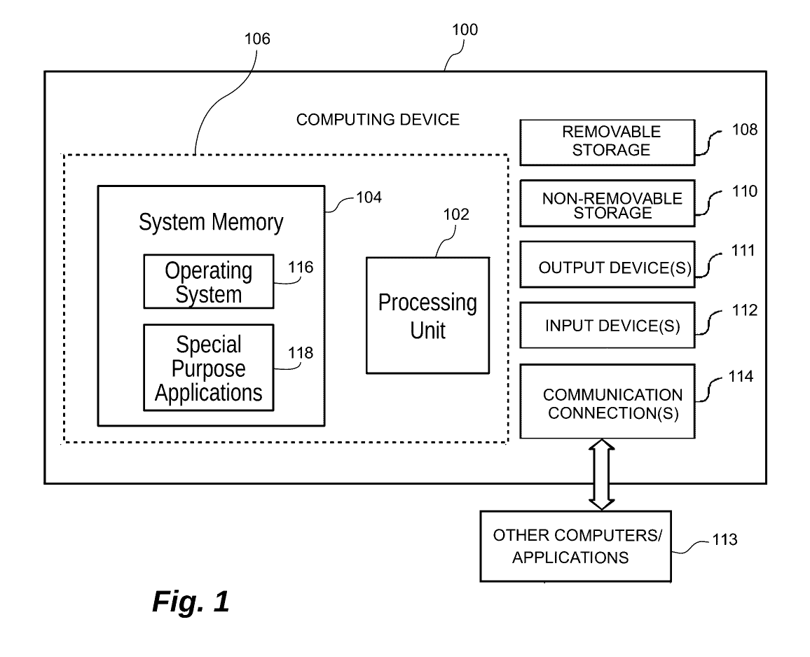

FIG. 1 is a functional block diagram of an exemplary computing device 100 that may be used to implement one or more embodiments. The computing device 100, in one basic configuration, includes at least a processor 102 and a memory 104. Depending on the exact configuration and type of computing device, memory 104 may be volatile (such as RAM), non-volatile (such as ROM, flash memory, etc.), or some combination of the two. This basic configuration is illustrated in FIG. 1 by dashed line 106.

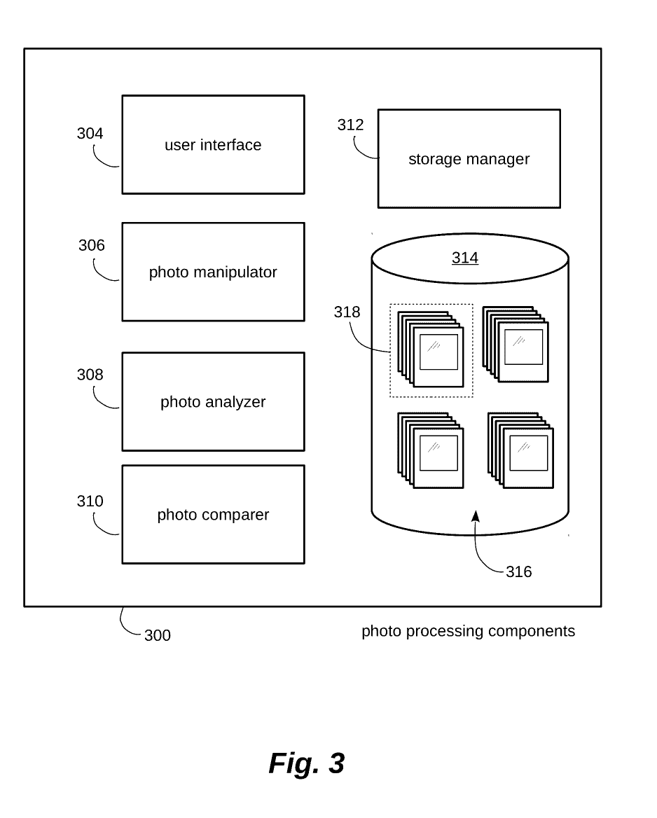

Memory 104 includes at least an operating system 116 and may additionally include other special purpose components 118. The operating system 116 includes the core functionality to enable the computing device 100 to operate, such as a file system, memory management, and a graphical user interface. The special purpose components 118 may include any one or more additional components to implement functionality on the computing device 100. Examples of special purpose components 118 are numerous, and include word processing components, spreadsheet components, web browsing components, and the like. One particular example of a special purpose component to implement functionality of the preferred embodiment is illustrated in FIG. 3 and described below.

Additionally, device 100 may have other features and functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Computing device 100 includes one or more communication connections 114 that allow computing device 100 to communicate with one or more computers and/or applications 113. The communication connections 114 may take the form of an Ethernet interface, WiFi interface, Bluetooth interface, USB connection, eSATA connection, mobile network radio, or the like. Device 100 may also have input device(s) 112 such as a keyboard, mouse, digitizer or other touch-input device, voice input device, digital camera, or the like. Output device(s) 111 such as a monitor, speakers, printer, PDA, mobile phone, and other types of digital display devices may also be included. These devices are well known in the art and need not be discussed at length here.

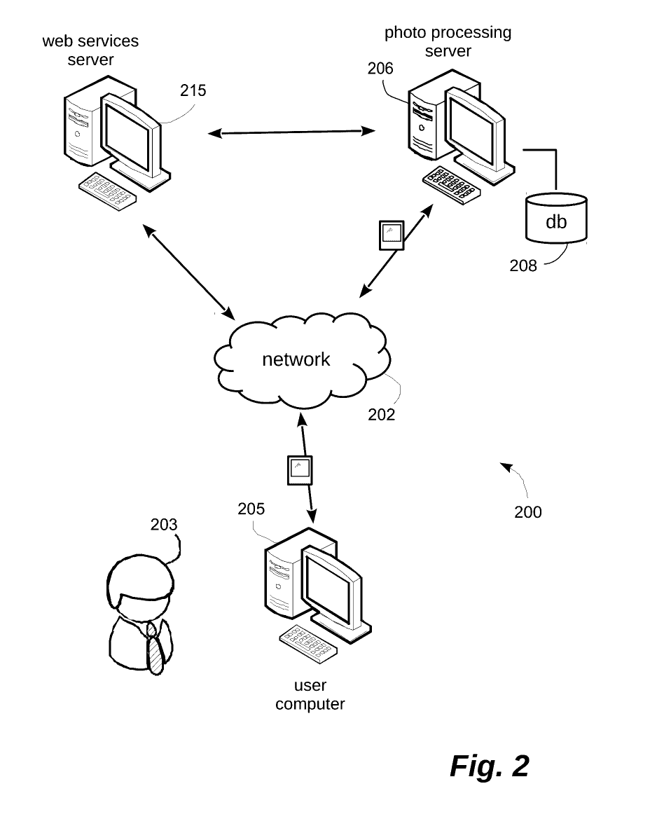

FIG. 2 is a graphical illustration of a computing environment 201 in which embodiments of the invention may be implemented. The computing environment 200 may be implemented using ordinary computing devices, such as the computing device illustrated in FIG. 1 and described above, configured in accordance with the teachings of this disclosure. Specific functionality that may be distributed over one or more of the computing devices illustrated in FIG. 2 will be described in detail in conjunction with FIGS. 3-9. However, as an overview, the general operations performed by one embodiment will be described here in conjunction with FIG. 2.

The computing environment 200 includes at least a user computer 205 and a photo processing server 206 connected over a network 202. The network 202 can be any electrical components and supporting software and firmware for interconnecting two or more disparate computing devices. Examples of the network 202 include a local area network, a wide area network, a metro area network, the Internet, a mobile data network, and the like.

In this implementation, the user computer 205 represents a computing device, such as the computing device illustrated in FIG. 1, that an entity (user 203) uses to perform operations on digital photographs or images. The user computer 205 may incorporate a digital camera for capturing digital images, a scanner for digitizing existing photographs, or a connection for receiving digital photographs, such as from a portable digital camera (which can be a mobile phone that incorporates a digital camera). In addition, the user computer 205 may be used to connect to other computing devices over the network 202. Although illustrated as a human being, it should be noted that the user 203 could be any form of entity or agent capable of performing computer searches or information retrieval, such as another automated system.

A photo processing server 206 is a computing device, such as the computing device illustrated in FIG. 1, that includes components for processing digital photographs to attempt to distinguish a subject from a background of the photograph. Typically, the user computer 205 presents a digital photograph to the photo processing server 206 which in turn analyzes the digital photograph to distinguish the subject from the background. In one embodiment, such analysis involves some interaction with the user 203 to assist in the analysis. The operations and analysis are described in greater detail below.

The photo processing server 206 further includes a data store 208 in which are stored digital representations of known or anticipated backgrounds for a particular user. More specifically, user 203 may provide one or more digital photos to the photo processing server 206, which then distinguishes subject from background in each photo. The photo processing server 206 stores representations of each background recognized in the photos. In this embodiment, the representations are stored in the data store 208.

When the photo processing server 206 subsequently receives another digital photo from the user 203, the photo processing server 206 performs a background analysis on the new photo to compare the new photo with the stored representations of known backgrounds in the data store 208. Under circumstances indicating that the new photo includes a known background, the photo processing server 206 performs an analysis comparing the new photo to the known background to greatly simply identifying the subject of the new photo. In some circumstances, the user 203 may be prompted to confirm that the new photo does indeed include a known background.

A web services server 215 may also be included in the computing environment 200. The web services server 215 of this embodiment may implement a service that assists users to advertise products for sale, such as through online auction or the like. In one specific example, the web services server 215 may enable users to upload images of products which the users desire to offer for sale. The web services server 215 may then facilitate advertising those products through one or more online catalogs of products which various other visitors may browse and search over the network 202. The web services server 215 may additionally, or alternatively, conduct operations to list the users' products with other, third-party online auctions or digital storefronts.

Although illustrated as separate computing devices, it should be appreciated that the various functions and components of the several computing devices shown in FIG. 2 could be implemented in ways other than as shown. For example, the photo processing components of the photo processing server 206 could be either in part or in whole resident on the user computer 205. In one such implementation, the user computer 205 may connect to the photo processing server 206 and those photo processing components could be downloaded to the user computer 205 at which they are used. Alternatively, the photo processing components could be pre-installed on the user computer.

Similarly, the web services server 215 may operate in conjunction with the photo processing server 206 to provide a web service to the user 203 while also offering the photo processing service of the photo processing server 206. Alternatively, the photo processing components of the photo processing server 206 could be resident on the web services server 215. These and other alternatives will be apparent to those skilled in the art.

FIG. 3 is a functional block diagram generally illustrating photo processing components 300 which may implement the preferred embodiment. The illustrated components are merely examples, and other components may be implemented which combine, divide, or eliminate certain functions without deviating from the spirit and scope of the disclosure.

The photo processing components 300 include a user interface 304 and a photo manipulator 306. In this embodiment, the user interface 304 enables a remote computing device, such as user computer 205, to interact with or control the several photo processing components 300, including specifically the photo manipulator 306. The photo manipulator 306 provides functionality to allow a user to manipulate elements of a digital photo and to provide input regarding elements of the digital photo. Specifically, the photo manipulator 306 allows a user to identify or select one or more elements of the photo for the purpose of identifying whether those elements are either background or subject. The photo manipulator 306 may also, optionally, be configured to allow certain visual effects to be applied to the photo, such as a sepia effect, black-and-white effect, cartoonish effect, or the like.

A photo analyzer 308 is provided and which includes functionality to analyze a photo to discern characteristics of the photograph. For instance, the photo analyzer 308 is configured to construct a histogram or histograms for the photo to identify characteristics of each pixel or groups of pixels of the photo. The photo analyzer 308 may be further configured to enable the user, using the photo manipulator 306, to selectively alter certain characteristics of the photo. Examples of characteristics that may be altered include, but are not limited to, brightness, saturation, color temperature, and the like. The photo analyzer 308 is further configured to store the characteristics of a photo, or the photo itself, or both the photo and its characteristics in a background profile data store 314.

The background profile data store 314 includes a number of representations of backgrounds (“background profiles”) associated with a particular user. The background profile data store 314 may include numerous background profiles 316 grouped or correlated by user. For example, background profiles 318 may be one or more background profiles associated with one particular user. Although described here as being correlated by “user,” it should be appreciated that a “user” could be one account which multiple individuals use, or it could be multiple accounts which one individual uses, or any other combination. Accordingly, the term user does not imply an individual. Alternatively, the background profiles 316 could, conceivably, not be correlated by users and instead be a undifferentiated grouping of background profiles

A photo comparer 310 is included and is configured to perform a comparison of one photo to another photo. The photo comparer 310 works in conjunction with the photo analyzer 308 to gather the several characteristics for each of two or more photos and performs a comparison of the characteristics of one photo to the characteristics of another photo. The photo comparer 310 performs operations to make a probabilistic determination whether at least some elements of one photo are present in another photo. Specifically, in the preferred embodiment, the photo comparer 310 is configured to compare a new photo to background profiles stored in the background profile data store 314 to determine if the new photo includes a known background profile.

The photo comparer 310 could, conceivably, compare a new photo against any background profile 316 in the entire background profile data store 314. However, ideally the background profiles 316 are correlated by user given that similar backgrounds are far more likely with the same user than with different users.

Briefly stated, by using background profiles 316, the photo processing components 300 can more easily differentiate a subject of a photo from its background. In other words, when presented with a new photo for which it is desired to identify a subject, comparing the new photo to known background profiles greatly simplifies the process of identifying the background. Once the background of the photo is known, identifying the subject is substantially simpler using methods for discriminating objects within a photo.

Although any method for discriminating between objects within a photo may be used, certain exemplary methods are provided below for completeness of disclosure. However, the methods described should not be viewed as limiting as any alternative method for distinguishing objects within a photo may be used without deviating from the spirit and scope of the disclosure.

### Illustrative Processes For Picking Background Profiles

The principles and concepts will now be generally described with reference to sample processes that may be implemented by a computing device, such as the computing device illustrated in FIG. 1, in certain embodiments. The processes may be implemented using computer-executable instructions in software or firmware, but may also be implemented in other ways, such as with programmable logic, electronic circuitry, or the like. These processes are not to be interpreted as exclusive of other embodiments, but rather are provided as illustrative only.

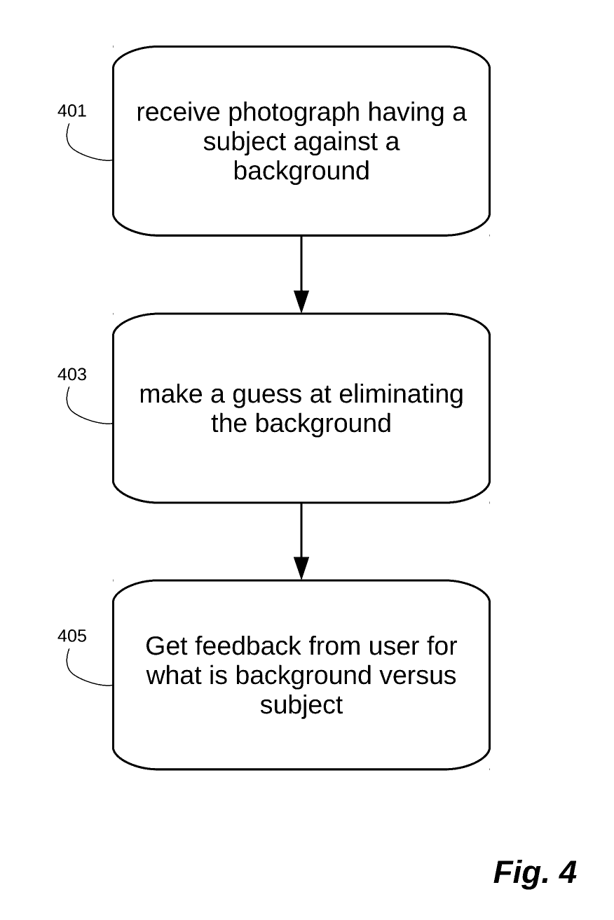

FIG. 4 is a flow diagram generally illustrating a most basic process 400 for implementing background profiles in accordance with one embodiment. As illustrated in FIG. 4, the process 400 begins when a photo is received which contains a subject against a background. (Step 401). In one example, the photo may be of an item which a user desires to sell. The photo may be taken of the item under ordinary circumstances meaning in an ordinary environment with the ambient background.

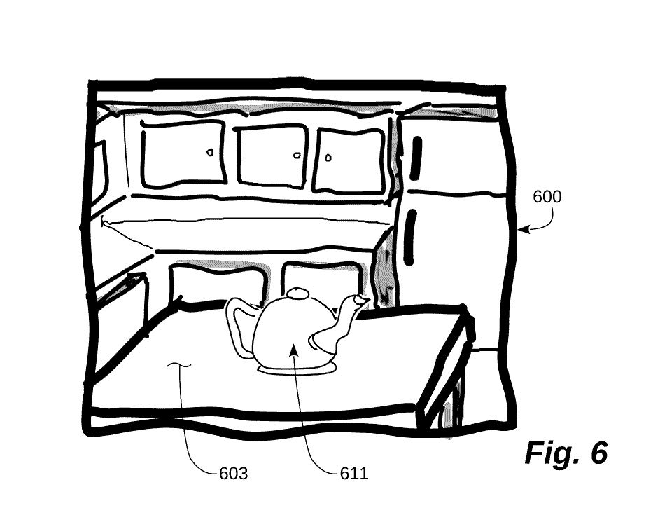

In one classic example, and referring briefly to FIG. 6, an item may be, for instance, a tea kettle 611 and the photo 600 may be taken of the tea kettle 611 resting on a kitchen table 603 in a kitchen. Thus, the subject of the photo 600 is the tea kettle 611. However, the subject is surrounded by the background images of a kitchen. Accordingly, it is desired to differentiate the subject (the tea kettle 611) from the background (the kitchen surroundings).

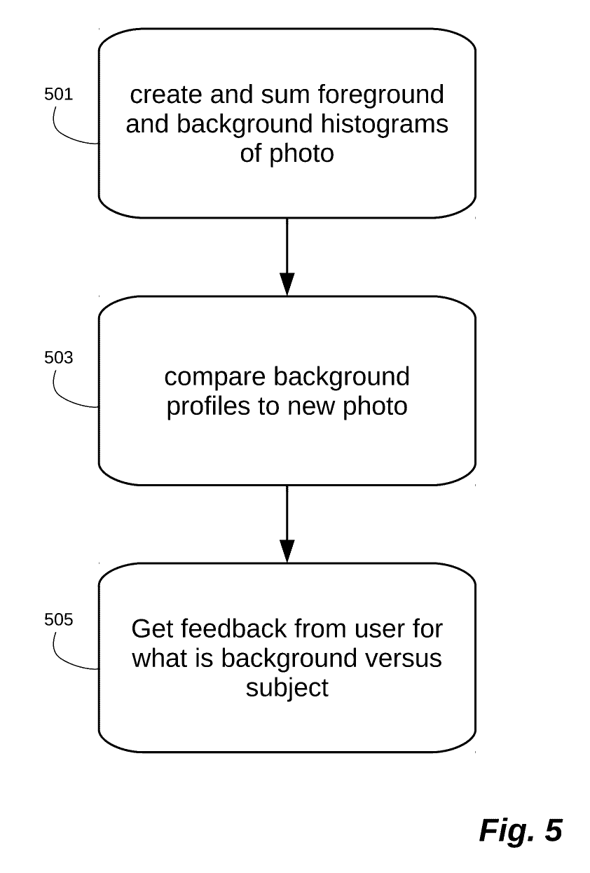

Returning to FIG. 4, a “guess” is made at eliminating the background portion of the photo. (Step 403). In this embodiment, the guess constitutes a comparison of the photo with known background profiles in an attempt to determine if the photo includes a known background. In one example, the photo is compared to information discerned from analysis of previous photos to determine if the photo includes a previously-identified background. In other words, preexisting background profiles are compared to the new photo to determine if a statistically significant match exists. One particular technique for performing the comparison is described below in conjunction with FIG. 5, although any appropriate method for comparing two photos may be used.

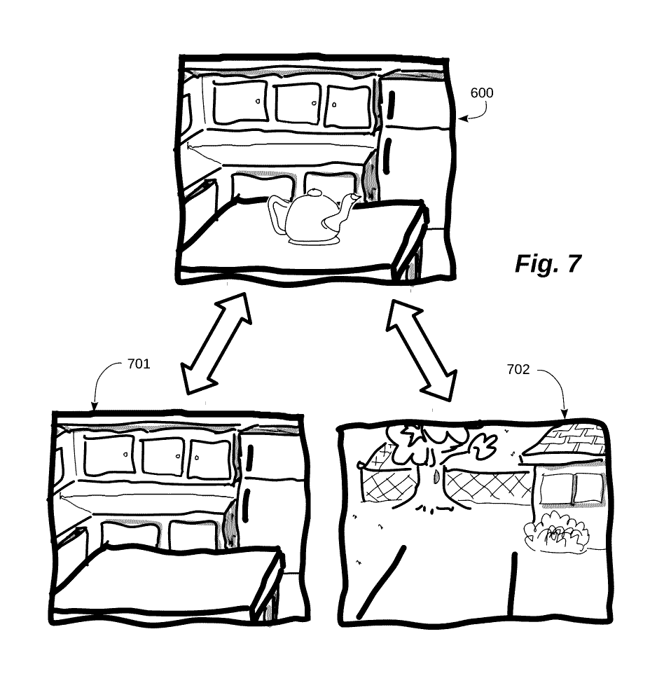

Referring briefly to FIG. 7, a preexisting background profile 700 may exist for the particular user. In such a case, the new photo 600 may be compared to known background profiles, such as a first background profile 701 and a second background profile 702, in an attempt to simplify the process of identifying the background of the new photo. The comparison reveals that the new photo 600 statistically matches the first background profile 701 closely, yet differs significantly from the second background profile 702. Accordingly, the first background profile 701 is used to guess the background portion of the new photo 600. Elements of the new photo 600 which correlate to the first background profile 701 are identified as being likely background portions.

Once an estimate is made, the user is prompted for feedback regarding which object or objects constitute the background of the photo. (Step 405). In one embodiment, the user is prompted to select which of one or more identified objects within the photo 600 is the subject.

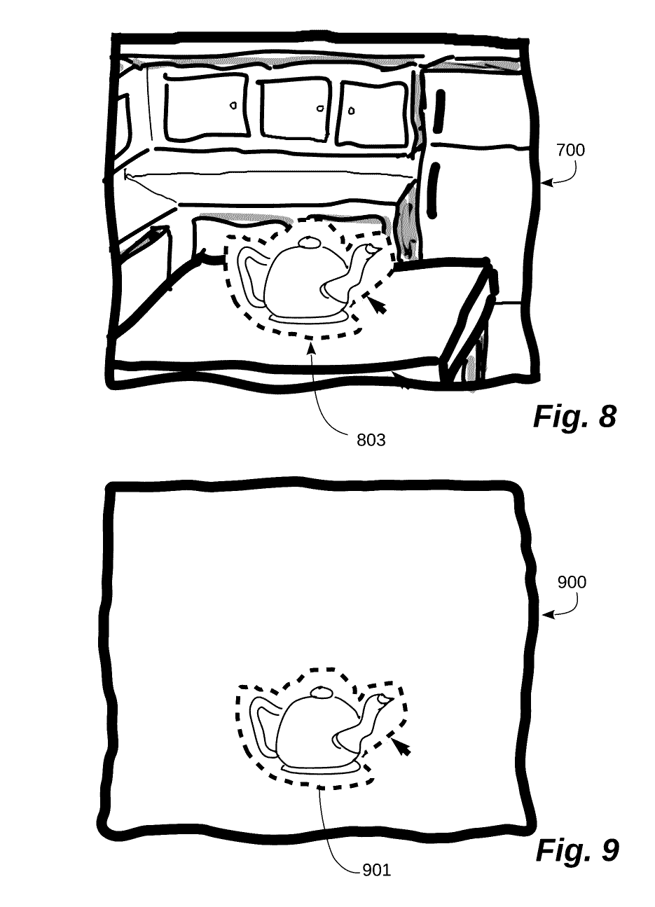

Referring briefly to FIG. 8, the user may be prompted to select 803 the actual subject from objects identified during the estimation process. The selection could be a simple identification of actual objects already identified, or it could take the form of affirmatively outlining the intended subject.

Using the feedback from the user, the background profile 701 may be updated with additional information to improve the accuracy of subsequent comparisons. Referring now briefly to FIG. 9, once the complete background has been identified, it may be eliminated from the photo 900 leaving only the subject 901.

FIG. 5 is a flow chart generally illustrating in greater detail a process 500 for comparing known background profiles against a new photo to determine whether they are a match. To build a background profile, the background and foreground histograms of a photo are summed. Their difference (inverse of “similarity” below) is saved as a “color significance” which can feed into an aggressive pixel matching background version. (Step 501). Alternatively, a “mask_significance” could be used depending on the consistency of the background masks. The histograms could then be stored to save time in subsequent analyses.

A comparison is performed of the new photo to a background profile to determine if the background profile is similar to in width & height to the new photo. (Step 503). The histogram may also be effective without matching the sizes of the photos.

A determination is made of how similar are the probable background regions of the new photo and the background profile. (Step 505). The determination could be made by first converting a raw number of pixels for each photo to a percentage of the image. Alternatively, the two histograms could be normalized to add up to same number of pixels. Subtract one histogram from the other. When performing the subtraction, allow pixels to match (=subtract) if they are within a fuzzing range of each ether.

The difference between the two histograms is compared to some threshold, such as 75% or 90% similarity. (Step 507). If the similarity between the two histograms exceeds the threshold, a match is considered likely. Otherwise, an alternative background profile is analyzed.

Additional information may also be used in the similarity comparison. For example a difference in time between when the background profile photos were submitted versus when the instant photo was submitted. In another example, it may be determined how many different background profiles have been applied since the last time a given background profile was used. The longer since a background profile was applied, the less likely that it will apply to the instant photo being analyzed.

Finally, if the similarities between the new photo and the subject background profile are considered “high” (based on some predetermined threshold), then a straight pixel-based color matching filter can be performed with the difference between the color values of the background profile and the instant photo being summed to give an approximation of the relative degree of difference between the two. In this comparison, the pixel values of the instant photo could be modified by a scalar to account for differences in brightness or hue between images that are otherwise the same. If not, use “Color” or “Raw” shape bundle, and mark any bundles within some threshold of histogram and mask position as “BG” as one of the filters

A similarity score may be computed and used in the comparison. For example, the likelihood of a match could, in one implementation, be calculated using a formula such as:

Likelihood=(BP match % of result)*BP histogram separation

Illustrative Technique For Distinguishing Subject From Background

What follows is an illustrative technique or process that may be used to identify individual objects within a photo for the purpose of distinguishing subject from background. This technique is one of many alternative processes that may be implemented in various embodiments. This illustrative process is described here for completeness of disclosure and not as an example of the only technique that can be implemented in embodiments.

The preferred embodiment of the process begins by running a series of canny image thresholds on the initial image in an effort to build a mosaic of shapes that represent regions (also referred to as “shapes”) of the image being processed. The coarser canny thresholds (those with fewer lines) are considered more authoritative in revealing where the meaningful boundaries between shapes lies. However, these coarse canny processing passes typically leave many shapes in the mosaic unclosed.

To close the shapes, the preferred embodiment superimposes the results of increasingly detailed canny passes, discarding as noise lines that aren't connected to the result of the previous (coarser) canny pass. The superset of canny results may be referred to as a “Supercanny.” With each new canny generated, lines that are connected to the coarser canny get stored, and after a few passes almost all meaningful regions within an image are closed.

The final step in completing the Supercanny is to try to extend each dangling line by a length proportional to the distance from the end of the dangling line back to the previous junction between that line and some other line. The logic here is that if there is a long line that is connected to many other lines, it has a higher likelihood of being random noise (e.g., from a pattern in the original image), whereas if the line spans a great distance from its junction point to where the line ends, then it is more likely to be a line of significance that should be made into a closed region if possible. To extend the line, the process backtracks from a point at which the line ends to a reasonable distance (such as something in the range of 5-10 pixels) and then draws a line out from the dangle point that has the same rise/run as the section of the line just previous to where it ends off. This completes the Supercanny.

The next step is to process each closed region, saving into an object various properties of the region, including its average RGB values, the density of dangling canny lines contained in it, and the total pixel area of the region. In a typical image, there may be upwards of 500-1000 closed regions at this stage. Thus, the process consolidates these regions by grouping like regions. Each shape is analyzed, evaluating whether the shapes next to it are sufficiently similar in their attributes to merit being consolidated. The smaller the region, the stronger its difference must be with adjacent shapes to not be consolidated. Conversely, the bigger a shape is, the more likely it will subsume the shapes around it, unless they are significantly different than the large shape. Factors used to determine potential merges include the RGB values, the distance of shared edge between shapes, and the texture similarity between the shapes (as approximated by Sobel image).

By this point, the process will have reduced the total number of shapes by at least 2×. Thus, the process proceeds to build groups of shapes. The process of grouping shapes does not destroy them during the consolidation, as may occur in the previous step. It uses a more detailed heuristic than the consolidation used when converting the closed regions in the previous step.

Shapes are bundled if they are sufficiently similar across the following dimensions: texture (approximated by Sobel), distance between center of gravity, distance from image border, pixels count inside shape, and the actual RGB values of the shapes. These values are added together, and if the difference between the shapes is small enough, they become part of the same “shape group.”

Next, the process may runs several passes on the shape groups, classifying each group with a designation, such as 0-3, corresponding to the likelihood that the group is foreground or background. These designations may be passed to a grabcut algorithm in a subsequent step. Because there will be a relatively small number of shape groups after a series of consolidations, the process can quickly experiment with numerous configurations of shape groups being marked as foreground or background.

One configuration is the “edge discard” set. In this arrangement, the process loops around the edge of the photo, marking as background any shape group that touches the edge of the picture, other than, perhaps, the bottom edge. The assumption in this configuration is that it is rare for a product photo to intersect any non-bottom edge of the picture. Humans who make their way into product photographs are known for intersecting the bottom edge of photos. It is a function of common physics.

Another configuration is the “foreground-centric” set. In this arrangement, any shape group that shares a similar color to the dominant shape group in the center of the photograph his assumed to be foreground. This configuration is useful for correctly cropping items like jeans, that tend to be of uniform color. The inverse of this configuration is “background-centric,” where any shape group that matches the dominant color in shape groups on the periphery of the picture is marked as “background.”

The arrangements specified above (plus any number of other arrangements) are analyzed for sanity. For example, do the areas marked as “foreground” exceed 5% of the image area and fall under 90% of the area? Do those areas intersect only a limited portion of the edge of the image? If so, they may be sent through the grabcut algorithm. The grabcut algorithm is known in the art and is freely available through the OpenCV library. It takes a mask labeled 0-3 and iterates on it to match like-with-like, giving a result that tends to be somewhat more pixel-perfect than the shape groups themselves.

Finally, the illustrative process rates the results of the resultant images that emerge from the grabcut algorightm based on a series of heuristics often shared by good product photographs. For instance, is the center of mass near the center of the photo? The nearer to the center of the photo, the more highly it rates. Does the image involve fewer “islands,” or areas surrounded by background? Islands often indicate an imperfect result.

The process may send the highest rated image crops to the user for the user to select the image that most perfectly matches the user's intention. The user's selections may be recorded over time to establish which arrangements of shape groups tend to be the most successful.

Still other alternative methods include identifying the foreground of a subject by creating a paint-by-numbers picture, ensuring that every object in the picture has an outline around it. Generally stated, this embodiment breaks an image into granular parts, and iteratively combines pieces into increasingly larger groups using heuristics that describe the nature of typical product pictures. A further enhancement matches such a paint-by-numbers picture to a foreground probability map to identify the objects most likely to be foreground (in the case of humans, a Haar detector can be used to identify a face, then use a 2D humanoid form to build a probability map (i.e., the area directly under the face is most likely to be the human and the subject of the picture)).

Yet another method associates related shapes to make a broader guess about the nature of the foreground given a set of probable foreground shapes.

Still another method involves making a series of guesses and running them through a heuristic algorithm to determine which one has the most characteristics in common with a valid result. The results of that method can be presented to a user for refinement.

Another method includes taking an image that the user eventually chooses (after having possibly applied the user's own hand-edits to the machine-generated background profile), and feeding that result back intro the process to use to improve future results.

Using these methods, results may be improved by identifying colors and shapes that tend to be in the foreground/background of a given user's photos. In addition, results may be improved by identifying broader patterns that tend to occur across all users who use the tool. For example, past results could help continuously refine the ideal location of our foreground probability map.

These and other uses and alternatives will become apparent from the foregoing teachings.

In this description, numerous details have been set forth in order to provide a thorough understanding of the described embodiments. In other instances, well-known features have not been described in detail in order to not obscure unnecessarily the description.

A person skilled in the art in view of this description will be able to practice the present invention, which is to be taken as a whole. The specific embodiments disclosed and illustrated herein are not to be considered in a limiting sense. Indeed, it should be readily apparent to those skilled in the art that what is described herein may be modified in numerous ways. Such ways can include equivalents to what is described herein. In addition, the invention may be practiced in combination with other systems. The following claims define certain combinations and subcombinations of elements, features, steps, and/or functions, which are regarded as novel and non-obvious. Additional claims for other combinations and subcombinations may be presented in this or a related document.

The invention is:

1. A method for discriminating a subject from a background in a photograph, comprising:
performing an analysis of a first digital image, the first digital image having a first subject and a first background;
based on the analysis of the first digital image, discriminating the first subject from the first background;
storing information in a data store of background profiles, the information being related to the first background;
performing an analysis of a second digital image, the second digital image having a second subject and a second background;
comparing information derived from the second digital image to the information in the data store of background profiles to determine if the second background resembles the first background;
if the second background matches the first background, using information derived from discriminating the first subject from the first background to assist in discriminating the second subject from the second background.

2. The method recited in claim 1, wherein the analysis of the first digital image includes prompting a human user for input to be used in the analysis.

3. The method recited in claim 1, wherein information related to the first background comprises the first background.

4. The method recited in claim 1, wherein the second background resembles the first background if similarities between data representing the first background and data representing the second background exceed a statistical threshold.

5. The method recited in claim 4, wherein the similarities between the data representing the first background and the data representing the second background is calculated according to a statistical matching formula.

6. The method recited in claim 5, wherein the statistical matching formula comprises:
Likelihood=(BP match % of result)*BP histogram separation
wherein “BP” corresponds to a Background Profile.

7. The method recited in claim 1, wherein if the second background does not resemble the first background, repeating the comparison of the second digital image to other information in the data store of background profiles to determine if the second background resembles a different background profile stored in the data store.

8. The method recited in claim 1, wherein the comparison of information derived from the second digital image to the information in the data store of background profiles further comprises normalizing the information derived from the second digital image to the information in the data store.

9. The method recited in claim 1, wherein assisting in discriminating the second subject from the second background further comprises prompting a user for confirmation of the discrimination of the second subject from the second background.

10. A system for discriminating a subject from a background in a photograph, comprising:
an image processing server on which executes an image analysis engine configured to analyze a first digital image, the first digital image having a first subject and a first background, the analysis including a discrimination of the first subject from the first background;
the image processing server further comprising a profile manager configured to store information about the first background in a background profile data store;
the image processing server further comprising an image comparison component configured to compare a second digital image to data stored in the background profile data store, the comparison identifying whether the second digital image includes data that resembles the first background.

11. The system recited in claim 10, wherein the analysis of the first digital image includes prompting a human user for input to be used in the analysis.

12. The system recited in claim 10, wherein information related to the first background comprises the first background.

13. The system recited in claim 10, wherein the second background resembles the first background if similarities between data representing the first background and data representing the second background exceed a statistical threshold.

14. The system recited in claim 13, wherein the similarities between the data representing the first background and the data representing the second background is calculated according to a statistical matching formula.

15. The system recited in claim 14, wherein the statistical matching formula comprises:
Likelihood=(BP match % of result)*BP histogram separation
wherein “BP” corresponds to a Background Profile.

16. The system recited in claim 10, wherein if the second background does not resemble the first background, repeating the comparison of the second digital image to other information in the data store of background profiles to determine if the second background resembles a different background profile stored in the data store.

17. The system recited in claim 10, wherein the comparison of information derived from the second digital image to the information in the data store of background profiles further comprises normalizing the information derived from the second digital image with the information in the data store.

18. The system recited in claim 10, wherein the image processing server further comprises a user interface component configured to prompt a user with a proposed identification of the second subject in the second digital images using the information about the first background.
